(19) United States
(12) Patent Application Publication
(10) Pub. No.: US 2009/0088106 A1
(43) Pub. Date: Apr. 2, 2009

(54) RADIO FREQUENCY FILTERING

(75) Inventors: Chien-Meen Hwang, San Jose, CA (US); Ann P. Shen, Saratoga, CA (US)

Correspondence Address: FISH & RICHARDSON P.C., P.O. BOX 1022, MINNEAPOLIS, MN, 55440-1022, US

(73) Assignee: NANOAMP SOLUTIONS INC. (CAYMAN), Santa Clara, CA (US)

(21) Appl. No.: 12/171,544

(22) Filed: Jul. 11, 2008

Related U.S. Application Data
(60) Provisional application No. 60/975,732, filed on Sep. 27, 2007.

(51) Int. Cl. H04B 1/18

(52) U.S. Cl. 455/150.1

(57) ABSTRACT

Radio frequency filtering includes receiving a signal and detecting a change in the direct current (DC) offset of the signal or a change in a component that affects the DC offset of the signal. The filtering also includes setting a cut-off frequency of a high-pass filter to a first frequency value in response to the detected change and filtering the signal using the high-pass filter with the cutoff frequency set to the first frequency value. The filtering further includes adjusting the cutoff frequency of the high-pass filter from the first frequency value to a second frequency value while filtering the signal using the high-pass filter where the second frequency value is less than the first frequency value.

### CROSS REFERENCE TO RELATED APPLICATIONS

This application claims the benefit of priority from U.S. Provisional Application entitled “RADIO FREQUENCY FILTERING”, Application No. 60/975,732 filed Sep. 27, 2007, the disclosure of which is incorporated by reference.

### TECHNICAL FIELD

This disclosure relates to signal filtering in radio frequency communications.

### BACKGROUND

Often it is desirable to remove direct current (DC) offset in a radio frequency (RF) receiver system. A high-pass filter can be used in RF receiver circuits to remove the DC offset.

### SUMMARY

Generally, implementations can involve adjusting the cutoff frequency of a high-pass filter that is used for DC cancellation. In addition, the techniques described here can be compatible with digital algorithms used in communication systems. The techniques set forth in the present disclosure can, for example, provide for a reduced settling time of the high-pass filter as well as a reduced level of a signal distortion due to the high-pass filter. The techniques can be used, for example, in response to a change in the DC offset level or a change in a component that affects the DC offset level.

According to one general aspect, a method comprises receiving a signal and detecting a change in the direct current (DC) offset of the signal or a change in a component that affects the DC offset of the signal. The method also comprises setting a cut-off frequency of a high-pass filter to a first frequency value in response to the detected change and filtering the signal using the high-pass filter with the cutoff frequency set to the first frequency value. The method further comprises adjusting the cutoff frequency of the high-pass filter from the first frequency value to a second frequency value while filtering the signal using the high-pass filter where the second frequency value is less than the first frequency value.

These and other implementations can optionally include one or more of the following features. For example, the cut-off frequency of the high-pass filter can be set to an initial frequency value such that setting a cut-off frequency of the high-pass filter to the first frequency value comprises adjusting the cutoff frequency from the initial frequency value to the first frequency value, the first frequency value being higher than the initial frequency value. The initial frequency value and the second frequency value can be the same. Detecting a change in the DC offset of the signal or a change in a component that affects the DC offset of the signal can comprise detecting a change in the DC offset of the signal. Detecting a change in the DC offset of the signal or a change in a component that affects the DC offset of the signal can comprise detecting a change in a component that affects the DC offset of the signal. Detecting a change in the component that affects the DC offset of the signal can comprise detecting a gain change.

These and other implementations can optionally include one or more of the following features. The method can also comprise maintaining the cutoff frequency value at the first frequency value for a first time period and maintaining the cutoff frequency value at the second frequency value until detecting a change in the DC offset of the signal or a change in a component that affects the DC offset of the signal. Adjusting the cutoff frequency of the high-pass filter from the first frequency value to the second frequency value can comprises adjusting the cutoff frequency from the first frequency value to a first intermediate frequency value, maintaining the cutoff frequency value at the first intermediate frequency value for a second time period, adjusting the cutoff frequency from the first intermediate frequency value to a second intermediate frequency value, and maintaining the cutoff frequency value at the second intermediate frequency value for a third time period. The first, second, and third time periods can be determined from values stored in a time period table. The first time period can be less than the second time period and the second time period can be less than the third time period.

These and other implementations can optionally include one or more of the following features. Adjusting the cutoff frequency of the high-pass filter from the first frequency value to a second frequency value can comprise adjusting the cutoff frequency value to one or more intermediate frequency values and adjusting the cutoff frequency from the one or more intermediate frequency values to the second frequency, the one or more intermediate frequency values being between the first frequency value and the second frequency value. Adjusting the cutoff frequency of the high-pass filter from the first frequency value to the second frequency value can comprise adjusting the cutoff frequency from the first frequency value to an intermediate frequency value, while the cutoff frequency is equal to the intermediate frequency value, determining that the DC offset of the signal is greater than a particular value, and adjusting the cutoff frequency from the intermediate frequency value to the second frequency value in response to determining that the DC offset of the signal is greater than the particular value. The first and second frequency values can be determined from values stored in a cutoff frequencies table.

According to a second general aspect, a system comprises a mixer configured to mix an input signal with a local oscillator signal, and an amplifier coupled to the mixer and configured to amplify a mixed signal. The system also includes a high-pass filter configured to filter an amplified and mixed signal. The system also comprises a control circuit configured to detect a change in the direct current (DC) offset of the signal or a change in a component that affects the DC offset of the signal, in response to the detected change, set a cut-off frequency of the high-pass filter to a first frequency value, and while the signal is filtered using the high-pass filter, adjust the cutoff frequency of the high-pass filter from the first frequency value to a second frequency value, wherein the second frequency value is less than the first frequency value.

These and other implementations can optionally include one or more of the following features. For example, setting the cut-off frequency of the high-pass filter to the first frequency value can comprise adjusting the cutoff frequency from an initial frequency value to the first frequency value, the first frequency value being higher than the initial frequency value. The initial frequency value and the second frequency value can be the same. Detecting a change in the DC offset of the signal or a change in a component that affects the DC offset of the signal can comprise detecting a change in the DC offset of the signal. Detecting a change in the DC offset of the signal or a change in a component that affects the DC offset of the signal can comprise detecting a change in a component that affects the DC offset of the signal. Detecting a change in the component that affects the DC offset of the signal can comprise detecting a gain change.

These and other implementations can optionally include one or more of the following features. The control circuit can be configured to adjust the cutoff frequency value to one or more intermediate frequency values and adjust the cutoff frequency from the one or more intermediate frequency values to the second frequency, the one or more intermediate frequency values being between the first frequency value and the second frequency value. The control circuit can be configured to maintain the cutoff frequency value at the first frequency value for a first time period and maintain the cutoff frequency value at the second frequency value until detecting a change in the DC offset of the signal or a change in a component that affects the DC offset of the signal. The control circuit can be configured to adjust the cutoff frequency from the first frequency value to a first intermediate frequency value, maintain the cutoff frequency value at the first intermediate frequency value for a second time period, adjust the cutoff frequency from the first intermediate frequency value to a second intermediate frequency value, and maintain the cutoff frequency value at the second intermediate frequency value for a third time period. The control circuit can be configured to determine the first, the second, and the third time periods from values stored in a time period table. The first time period can be less than the second time period and the second time period can be less than the third time period.

These and other implementations can optionally include one or more of the following features. The control circuit can be configured to adjust the cutoff frequency from the first frequency value to an intermediate frequency value, while the cutoff frequency is equal to the intermediate frequency value, determine that the DC offset of the signal is greater than a particular value, and adjust the cutoff frequency from the intermediate frequency value to the second frequency value in response to determining that the DC offset of the signal is greater than the particular value. The control circuit can be configured to determine the first and second frequency values from values stored in a cutoff frequencies table.

According to a third general aspect, a receiver comprises an antenna configured to receive a signal and a radio frequency filter configured to filter the signal. The receiver also comprises a low noise amplifier configured to amplify the filtered signal and a mixer configured to mix the output of the low noise amplifier with a local oscillator signal. The receiver further comprises an analog-to-digital converter configured to convert the signal after it has been mixed, and a digital signal processor configured to receive the converted signal. The digital signal processor is also configured to filter the converted signal as a digital high-pass filter and detect a change in the direct current (DC) offset of the signal or a change in a component that affects the DC offset of the signal, in response to the detected change, set a cut-off frequency of the digital high-pass filter to the first frequency value, and, while the signal is filtered using the digital high-pass filter, adjust the cutoff frequency of the digital high-pass filter from the first frequency value to the second frequency value, wherein the second frequency value is less than the first frequency value.

These and other implementations can optionally include one or more of the following features. For example, setting the cut-off frequency of the digital high-pass filter to the first frequency value can comprise adjusting the cutoff frequency from an initial frequency value to the first frequency value, the first frequency value being higher than the initial frequency value. The control circuit can be configured to adjust the cutoff frequency value to one or more intermediate frequency values and adjust the cutoff frequency from the one or more intermediate frequency values to the second frequency, the one or more intermediate frequency values being between the first frequency value and the second frequency value. The control circuit can be configured to adjust the cutoff frequency from the first frequency value to an intermediate frequency value, while the cutoff frequency is equal to the intermediate frequency value, determine that the DC offset of the signal is greater than a particular value, and adjust the cutoff frequency from the intermediate frequency value to the second frequency value in response to determining that the DC offset of the signal is greater than the particular value. The control circuit can be configured to determine the first and second frequency values from values stored in a cutoff frequencies table.

### DESCRIPTION OF THE DRAWINGS

FIG. 1 is a flow chart of an example of a process for adjusting a high-pass filter.

FIG. 2 is a flow chart of an example of a DC cancellation process.

FIGS. 3a and 3b are schematics of exemplary systems with DC cancellation circuits.

FIG. 4 is a schematic of an example of a low intermediate-frequency receiver with DC cancellation by a digital high-pass filter.

FIG. 5 is a schematic of an example of a direct-conversion receiver with high-pass filters.

FIG. 6 is a flow chart of an example of a DC cancellation process.

### DETAILED DESCRIPTION

In RF signal processing, DC offset can cause receiver performance degradation. In particular, a DC offset in an RF receiver can degrade detection or processing of the wanted signals. A high-pass filter can be used in receiver circuits to remove DC offset. High-pass filters generally allow higher frequencies to remain (“pass”) while blocking or attenuating lower frequencies.

High-pass filters can be characterized in terms of their “cutoff” frequency, which is the frequency, below which, a signal is significantly attenuated. The cutoff frequency may be the frequency, below which, a signal is attenuated by 3 dB, or 70.7% or more. A lower cutoff frequency for a high-pass filter, at times can achieve better performance at canceling or attenuating DC while passing wanted high frequency signal content.

As low frequencies are attenuated, signal distortion can result. As such, a side effect of using high-pass filters to remove DC offset may be the introduction of signal distortion into the signal. Moreover, the degree of signal distortion can increase as the extent of low frequency attenuation decreases (i.e., the frequency of the cutoff frequency increases). Therefore, to avoid signal distortion, a high-pass filter can be designed to have a lower cutoff frequency.

Another characteristic relevant for high-pass filters is the settling time or the time required for the filter to react to a signal and output a signal with less than a desired amount of error or distortion. It can be desirable to minimize settling time in order to increase the speed at which a high-pass filter can operate. In contrast to signal distortion, the settling time of a high-pass filter can increase as the extent of low frequency attenuation increases (i.e., as the cut-off frequency decreases). Consequently, to minimize settling time and/or meet a required timing constraint, a high-pass filter can be designed to have a higher cutoff frequency.

When using a high-pass filter for DC cancellation in RF receivers, it may be desirable to minimize both the distortion and the settling time. In order to satisfy requirements for minimizing both distortion and settling time, the cutoff frequency (and effectively the bandwidth) of the high-pass filter can be sequentially or continually adjusted. For example, a “gear shifting” process can be used to switch from a high cutoff frequency to a lower cutoff frequency. A high cutoff frequency can be initially used for the high-pass filter so as to achieve a fast settling time, and thereafter, the cutoff frequency can be lowered to reduce the signal distortion. Such a technique can take advantage of the fast settling time of a high cutoff frequency and reduced signal distortion of a lower cutoff frequency.

In various implementations, the gear-shifting process can be implemented in the digital domain using, for example, a digital signal processor (DSP). In a DSP, a high-pass filter can be designed to have parameters controlling the cutoff frequency. In particular, in the digital domain, the coefficient of a DC offset cancellation filter can be successively adjusted to affect the cutoff frequency and bandwidth of the high-pass filter. In some implementations, the gear-shifting process is implemented within a DSP working as an internal high-pass filter and control circuit. In other implementations, the gear-shifting DC cancellation process is implemented within a baseband or a dedicated digital filter.

In addition, or alternatively, the gear-shifting process can be implemented in the analog domain using, for example, an analog signal processor (ASP). An analog high-pass filter can be designed with an adjustable cutoff frequency. The cutoff frequency can then be successively adjusted to affect the bandwidth of the high-pass filter. As such, in some implementations, the gear-shifting process is performed with an ASP working as an internal high-pass filter. In other implementations, the gear-shifting is implemented with a dedicated analog high-pass filter controlled by a timing and control circuit.

In other implementations, digital high-pass filters and analog high-pass filters are implemented separately or in combination to perform the gear-shifting process. For example, digital and analog high pass filters may be implemented to perform the gear shifting process for applications in a wireless receiver with DC level change.

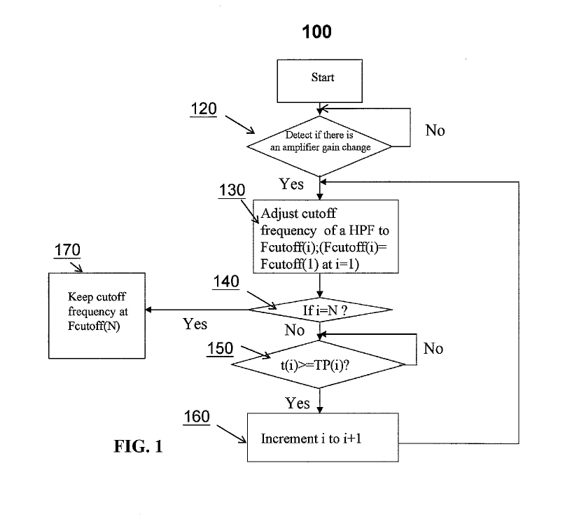

FIG. 1 is a flow chart of an example of a process 100 for adjusting a high-pass filter. The process 100 begins by detecting a gain change of an amplifier such as a low noise amplifier or automatic gain control (AGC) amplifier to determine if the gain is a new gain (or has changed from no gain to a gain of some detectable level) (120). The gain change detection can be performed by a digital and/or analog detection circuit. If the amplifier gain is not a new gain, the process 100 does not continue and can wait for a change in gain. In some implementations, the amplifier gain is detected (120) continuously and, in other implementations, the amplifier gain is detected (120) only at specific intervals or in specific circumstances.

If the amplifier gain is a new gain (e.g., the gain changes), the high-pass filter's cutoff frequency is adjusted to a value F(1) that is higher than the current value (i.e., the value before the amplifier gain change is detected) (130). Thereafter, the high-pass filter's cutoff frequency F_{cutoff}(i) is adjusted from the higher frequency value F(1) to a lower final steady state frequency value F(N) to provide for fast high-pass filter settling and less signal distortion. In the implementation shown, the cutoff frequency is adjusted (130) using a number of discrete cutoff frequency values represented by F_{cutoff}(i) with i=1,2, . . . N, where “N” is the total number of filter cut-off frequency adjustments. The cut-off frequencies, the number of adjustments and the lengths of the time intervals for each adjustment can be determined by design simulations, manual or automatic measurements, algorithm calculations or any other methods or combination of methods. The total number of iterations N can be a fixed number or a variable to be determined by, for example, a desired steady state DC level.

At the beginning of the cutoff frequency adjustment process (e.g., when a new gain is detected), the cutoff frequency is set at F_{cutoff}(1). Next, the index “i” is compared to “N” (140) and if i=N, the cutoff frequency is kept at F_{cutoff}(N) (170). If not, the current cutoff frequency is maintained for a certain time interval (150). For instance, for a given “i” the cutoff frequency F_{cutoff}(i) can be maintained for a time period TP(i). This may be done to provide the high-pass filter with sufficient time to settle.

As shown in process 100, a time interval “t(i)” for maintaining the cutoff frequency at F_{cutoff}(i) can be compared to a time period value TP(i) of a time-table at “i” (150). If “t(i)” is not equal or greater than the time interval TP(i) specified at “i”, the process 100 does not continue and can wait for the time t(i) to get to the end of “i” time period TP(i). The time period TP(i) for each cutoff frequency F_{cutoff}(i) can be stored in a time-table. The time period values within the time table need not be constant for different values of “i.” The time interval for a higher cutoff frequency can be shorter than that for a lower cutoff frequency. Therefore, the time period TP(i) may increase as the value of “i” increases, and the system may wait longer (150) at a later value of “i” than at an earlier value.

If “t(i)” is greater than the time interval TP(i) (the time interval expires), then “i” is incremented (160). Specifically, “i” is incremented to i+1 and the process 100 iterates to adjust the cutoff frequency to F_{cutoff}(i=i+1) (130) until it reaches F_{cutoff}(N) (170). The filter then continues filtering with the cutoff frequency of F_{cutoff}(N) and the process 100 can begin again. Specifically, the system filters with the cutoff frequency of F_{cutoff}(N) until a new gain change is detected (120).

In this manner, the cutoff frequency of a high-pass filter for DC cancellation can be gradually adjusted from a high cut-off frequency to a low cut-off frequency, which may provide for a faster settling time when there is a change in the filter's input (e.g., from an automatic gain control stage) and reduced distortion once steady state has been reached. Therefore, when the high-pass filter follows an amplifier gain stage and acts to cancel the DC offset, a faster settling time may be achieved when the gain is changed by using a higher frequency cut-off, and then the cut-off frequency can be gradually decreased to obtain less distortion after the filter reaches steady state. The process 100 can also be used for various components, including, for example, mixers, modulators, demodulators, A/D converters, multiplexers, switches, power supply, etc. which generate DC offset after a gain change.

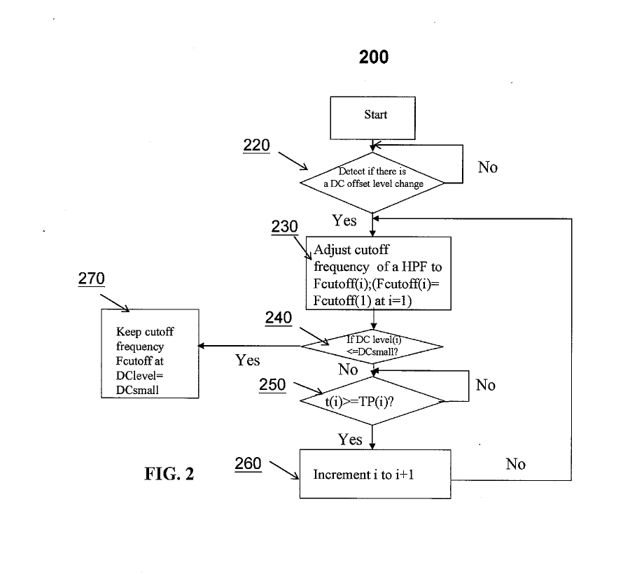

FIG. 2 is a flow chart of an example DC cancellation process 200. The process 200 can be used to cancel DC due to an amplifier gain change, and also due to other components with DC level changes such as mixers, switches, power supplies, A/D converters, demodulators or other components. Although the process 200 is described more with respect to a digital signal processing algorithm, other implementations may employ the steps more generally without specifically using the F_{cutoff}(i) algorithm or TP(i) algorithm.

The process 200 begins by detecting a DC offset level change (220). The DC offset level change can be detected by a digital and/or analog detection circuit. For example, a comparator can compare a measurement of the DC offset level with a threshold value in order to determine if there is a change in the DC offset level. If the DC offset level does not change, the process 200 does not continue and can wait for a change in the DC offset. In some implementations, the DC offset level is detected (220) continuously, in other implementations, the DC offset level is detected (220) only at specific intervals or in specific circumstances.

If the DC offset level changes, the high-pass filter's cutoff frequency is adjusted to an initial value that is higher than the current value (i.e., the value before the gain change) (230). In the process 200, the high-pass filter's cutoff frequency F_{cutoff}(i) is adjusted from a higher frequency F_{cutoff}(1) to the lower final steady state frequency F_{cutoff} (N) to provide for fast high pass filter settling and less signal distortion. In the implementation shown, the cutoff frequency is adjusted (230) using a number of discrete cutoff frequencies, similar to the example shown in FIG. 1.

At the beginning of the cutoff frequency adjustment process, the cutoff frequency is set at F_{cutoff}(1) Next, the DC level(i) is compared to a desired small value of the DC offset, DCₛₘₐₗₗ, to determine if the process 200 needs to continue to a lower cutoff frequency F_{cutoff} for the high-pass filter through steps 250 and 260. This step may also include checking against a desired F_{cutoff} value. If not, then the current cutoff frequency is maintained for a certain time interval (250). At the “i” iteration in the DC offset cancellation process 200, the cutoff frequency F_{cutoff}(i) can be maintained for a time period TP(i) to provide the high-pass filter sufficient time to settle.

As shown in process 200, a time interval “t(i)” for maintaining the cutoff frequency at F_{cutoff}(i) can be compared to a time period value TP(i) (250). If “t(i)” is not greater than the time interval TP(i) specified at “i,” the process 200 does not continue and can wait for the time t(i) to get to the end of “i” time period TP(i). The time period TP(i) for each cutoff frequency F_{cutoff}(i) can be stored in a time-table. The time period values within the time table need not be constant for different values of “i.” The time interval for a higher cutoff frequency can be shorter than that for a lower cutoff frequency. Therefore, the time period TP(i) may increase as the value of “i” increases, and the system may wait longer (250) at a later value of “i” than at an earlier value.

If “t(i)” is equal or greater than the time interval TP(i) specified in the time-table the process 200 moves to a following step of incrementing “i” (260). Specifically, “i” is incremented to i+1 and the process iterates to adjust the cutoff frequency for F_{cutoff}(i=i+1) (230) until the DC offset level is less than or equal to the desired value of the DC offset level, DCₛₘₐₗₗ(240), at which point the current cutoff frequency is maintained (270). The system then continues filtering with the maintained cutoff frequency and the process 200 can begin again. Specifically, the filter continues to filter with the maintained cutoff frequency until a new gain DC offset level is detected (220).

In one implementation, the time period TP(i) for each “i” iteration associated with a cutoff frequency of F_{cutoff}(i) is not determined using a time-table, but rather, is calculated dynamically. For example, to calculate the time period, the system may wait until a given DC offset level is measured.

The above describes examples, and other timing and/or incrementing methods can be used. Moreover, the F_{cutoff} and time tables are examples, and other methods can be used to store filter coefficient values or other values to be adjusted to affect the cutoff frequency of the high-pass filter.

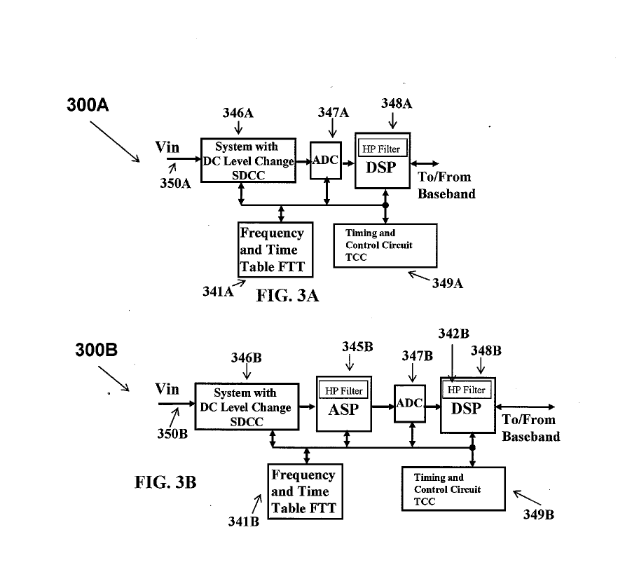

The disclosed techniques can be used with wireless communication systems. For example, the disclosed techniques can be used with receivers, transmitters, and transceivers, such as the receiver, transmitter, and/or transceiver architectures for superheterodyne receivers, image-rejection (e.g., Hartley, Weaver) receivers, zero-intermediate frequency (IF) receivers, low-IF receivers, direct-up transceivers, two-step up transceivers, and other types of receivers and transceivers for wireless and wireline technologies. FIGS. 3-5 are schematics demonstrating examples of systems in which the filtering techniques described above can be used.

FIGS. 3A and 3B are example schematics of systems 300A and 300B with DC cancellation circuits. The systems 300A and 300B can be used to carry out the process 100 or process 200 described with respect to FIGS. 1 and 2. The circuit 300A of FIG. 3A includes an RF signal Vᵢₙ 350a received by a component or a system with a DC level change (SDCC) 346A such as a low noise amplifier (LNA), a mixer, an automatic-gain-controlled amplifier (AGC) or a combination of two or more of these components as in a receiver. The output of the SDCC 346A can be digitized into digital signals by an analog to digital converter (ADC) 347A with the digital output coupled to a DSP 348A to perform digital filtering functions. The DSP 348A is controlled by a timing and control circuitry (TCC) 349A with frequency and time tables (FTT) 341A.

The TCC 349A and FTT 341A generally can be used in carrying out the processes 100 or 200. Implementations of the processes 100 or 200 employing the use of algorithms and other digital signal processing techniques can use the FTT 341A to provide the cutoff frequency and time period values. The baseband can send instructions to the TCC 349A via the DSP 348A or directly to change the gain or DC offset level in the SDCC 346A. The DSP 348A can detect the gain or DC offset level and can send an instruction to start the processes 100 or 200.

FIG. 3B is similar to FIG. 3A except the filtering process described in FIG. 1 can be performed by an analog signal processor ASP 345B placed between the SDCC 346B and the ADC 347B. The circuits described in FIGS. 3B and 3B can be used separately or in combination as shown in FIG. 3B with both an analog high-pass filter in ASP and a digital high-pass filter 342B in the DSP 348B to cancel DC offset with fast settling time and reduction of signal distortion. When used in combination, further performance improvement can be achieved. The digital high-pass filter 342B in FIG. 3B can cancel DC offset generated by the ADC circuit.

The following describes an example of process 100 implemented by the system shown in FIG. 3A. After an amplify gain change is detected by the DSP 348A, a first cutoff frequency F_{cutoff}(1) can be set at approximately ½ of the input signal bandwidth (BW) from the ADC 447 by the DSP 348A. The filtering iteration can be set for “N” iterations. The cutoff frequency F_{cutoff}(i) can be set to be F_{cutoff}(1)/2ⁱ⁻¹ for each iteration “i.” A time-table can provide the time period TP(i)=TP(1)*2ⁱ⁻¹. The time period TP(i) needed for the filter to settle can be approximately inversely proportion to the cutoff frequency F_{cutoff}(i) used. The HP filter uses a cutoff frequency of F_{cutoff}(1) for a time period of TP(1) initially. At the end of the first time period TP(1), a second filter frequency F_{cutoff}(2)=F_{cutoff}(1)/2 can be used until the end of the second time period TP(2) which can be set at TP(2)=TP(1)*2. The iteration process then proceeds to the 3^{rd} iteration with F_{cutoff}(3)=F_{cutoff}(1)*2² to filter the input signal from the ADC 347A by the DSP 348A. The process continues until iteration “N” is reached and F_{cutoff}(N)=F_{cutoff}(1)/2^{N-1} can be then kept for the digital filter in the DSP 348a until a gain change is detected.

In one implementation of amplifier gain change detection, information is sent to the DSP 348a from the baseband. For the case of a low IF receiver architecture for SDCC 346a, the input signal bandwidth to the DSP 348a can be assumed to be approximately 200 KHz. If F_{cutoff}(1) can be assumed to be 100 KHz and TP(1) can be assumed to be 1 μs, the total iteration number “N” can be 5. The steady state cutoff frequency can then be F_{cutoff}(5)=6.25 KHz which can be used for the high-pass filter in the DSP 348a until a gain change is detected.

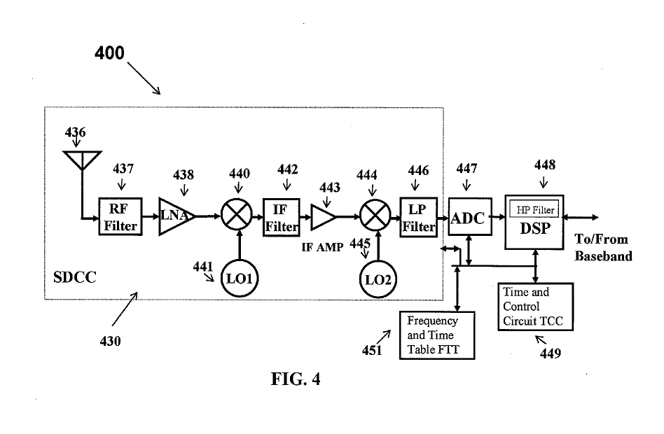

FIG. 4 is a schematic of a low-IF receiver 400. The SDDC 346A or 346B shown in FIG. 3A or 3B and is expanded in detail in FIG. 4 as SDDC 430. An RF signal arriving at an antenna 436 passes through a RF filter 437, an active LNA 438, enters the first mixer 440, which translates the RF signal down to an intermediate frequency by mixing it with the signal produced by the first local oscillator (LO) 441. The undesired mixer products in the IF signal are rejected by an IF filter 442. The filtered IF signal then enters an IF amplifier stage 443, into a second mixer 444 that translates it down to yet another intermediate frequency by mixing it with the signal produced by a second LO 445.

The signal is then sent to a low-pass filter 446, an ADC 447, to a DSP 448 which includes high-pass filtering functions, and then to the baseband for processing. Tuning into a particular channel within the band-limited RF signal is accomplished by varying the frequency of each LO 441 and 445. The TCC 449 with system information including gain change from the baseband and the FTT 451 are used to adjust the high-pass filter in the DSP 448. In particular, the DSP 448, the FTT 451 and the TCC 449 can be used to adjust the high-pass filtering functions in the DSP 448 using techniques such as those described in FIGS. 1 and 2 above.

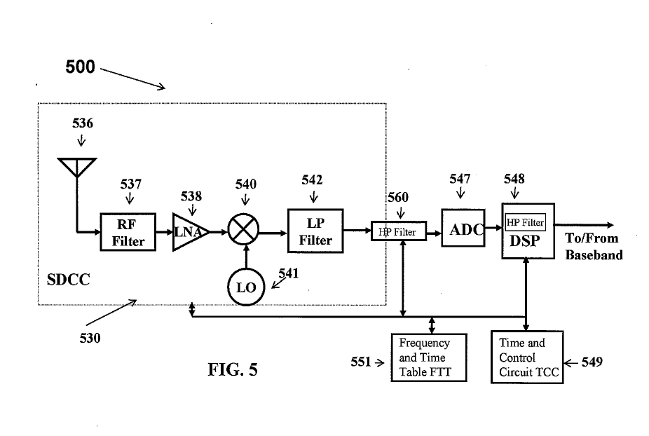

In another example, FIG. 5 is a schematic of a direct-conversion receiver 500 with high-pass filters. The gain change can occur in SDCC 530 and also from an ADC 547. An antenna 536 couples a RF signal through a first bandpass RF filter 537 into an LNA 538. The signal then enters a mixer 540 and mixes with a LO frequency produced by a LO 541. The mixer output is then sent to a low-pass analog filter 542, then to an analog high-pass filter 560 using multiple cutoff frequency techniques such as those described in FIGS. 1 and 2 above. The analog high-pass filter output is then digitized by the ADC 547, to a DSP 548 including soft high-pass filtering functions also using multiple cutoff frequencies, and then to the baseband for use by the remainder of the communications system. A TCC 549 with system information including gain change and a FTT 551 are used to adjust the high-pass filters. In particular, the DSP 548, frequency and time table 551 and the TCC 549 can be used to adjust the high-pass filters 560 and the softer high-pass filter in the DSP 548 using techniques described in, for example, FIGS. 1 and 2 above.

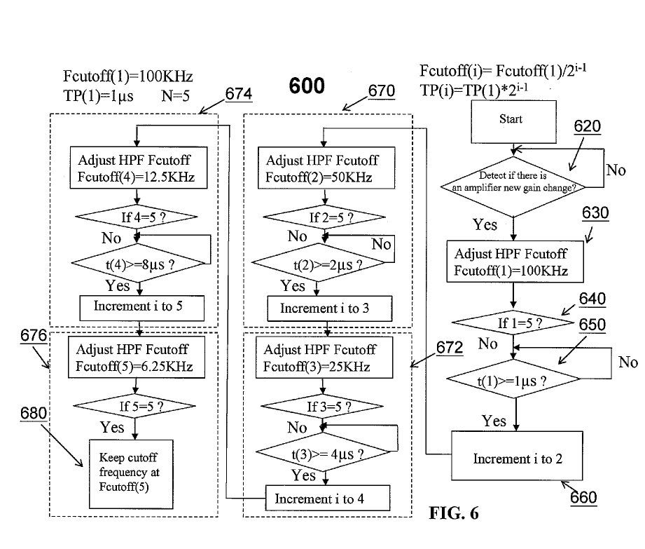

FIG. 6 is a more particular example of a process 600 using the DC offset cancellation techniques described above. Process 600 shows an example DC offset cancellation configured to balance the high-pass filter settling time with signal distortion. In the process 600, the initial high high-pass filter cutoff frequency is gradually adjusted to a steady-state lower high-pass filter cutoff frequency. For a low IF receiver (e.g., the low-IF receiver 400 described with respect to FIG. 4), the frequency to enter the high-pass filter can be assumed to be 200 KHz and the first cutoff frequency can be F_{cutoff}(1)=100 KHz. The iteration time can be assumed to be N=5 and the first time period TP(1) can be 1 μs.

When a new gain is detected (620), F_{cutoff}(1)=100 KHz is set and maintained during the first time period TP(1) of 1 μs (630). Next, it is determined whether the iteration has arrived to “N,” which can be set to 5 in this example (640). Then, the process checks if the time period TP(1) has expired (650). If not, the cutoff frequency of the high-pass filter stays at F_{cutoff}(1)=100 KHz until the end of 1 μs. At the end of 1 μs, the value of “i” is incremented from 1 to 2 (660).

Thereafter, the process 600 is repeated for a second iteration (670) which includes similar steps to steps 630-660. In the second iteration, a second F_{cutoff}(2) can be set to 50 KHz according to the equation F_{cutoff}(i)=F_{cutoff}(1)/2ⁱ⁻¹ for the time period TP(2)=2 μs according to the equation TP(i)=TP(1)*2⁻¹. Then, in a third iteration (672), the process 600 repeats for an increased value of “i” i=3 and with a third cutoff frequency of the high-pass filter F_{cutoff}(3)=25 KHz for a third time period of TP(3)=4 μs. In a fourth iteration (674), “i” is increased to i=4 for a fourth cutoff frequency of high-pass filter F_{cutoff}(4)=12.5 KHz for a fourth time period of TP(4)=8 μs. Finally, the process 600 is repeated for a fifth iteration (676) and “i” is increased to i=5=N for a fifth cutoff frequency of high-pass filter F_{cutoff}(5)=6.25 KHz. The cutoff frequency F_{cutoff}(5)=6.25 KHz is maintained (680) for a steady-state cutoff frequency of the high-pass filter until a next gain change is detected. By using the above technique of higher cutoff frequency initially and gradually decreasing the cutoff frequency to the steady-state cutoff frequency for the high-pass filter to cancel the DC offset in the system, the settling time of the high-pass filter for DC cancellation can be improved. The system then continues filtering with the cutoff frequency of F_{cutoff}(5)=6.25 KHz and the process 600 can begin again. Specifically, the filter can continue filtering with the cutoff frequency of F_{cutoff}(5)=6.25 KHz until a new gain change is detected (220), thereafter adjusting the cutoff frequency to a the higher initial value of F_{cutoff}(1)=100 KHz.

In some implementations, the positions of circuit components can be exchanged from the disclosed figures with minimal change in circuit functionality. Various topologies for circuit models can also be used. The exemplary designs shown can use various process technologies, such as CMOS or BiCMOS (Bipolar-CMOS) process technology, or Silicon Germanium (SiGe) technology. The circuits can be single-ended or fully-differential circuits.

The system can include other components. Some of the components can include computers, processors, clocks, radios, signal generators, counters, test and measurement equipment, function generators, oscilloscopes, phase-locked loops, frequency synthesizers, phones, wireless communication devices, and components for the production and transmission of audio, video, and other data. The number and order of amplifiers and filter stages can vary.

What is claimed is:

1. A method comprising:
receiving a signal;
detecting a change in the direct current (DC) offset of the signal or a change in a component that affects the DC offset of the signal;
in response to the detected change, setting a cut-off frequency of a high-pass filter to a first frequency value;
filtering the signal using the high-pass filter with the cutoff frequency set to the first frequency value; and
while filtering the signal using the high-pass filter, adjusting the cutoff frequency of the high-pass filter from the first frequency value to a second frequency value, wherein the second frequency value is less than the first frequency value.

2. The method of claim 1 wherein the cut-off frequency of the high-pass filter is set to an initial frequency value such that setting a cut-off frequency of the high-pass filter to the first frequency value comprises adjusting the cutoff frequency from the initial frequency value to the first frequency value, the first frequency value being higher than the initial frequency value.

3. The method of claim 2 wherein the initial frequency value and the second frequency value are the same.

4. The method of claim 1 wherein detecting a change in the DC offset of the signal or a change in a component that affects the DC offset of the signal comprises detecting a change in the DC offset of the signal.

5. The method of claim 1 wherein detecting a change in the DC offset of the signal or a change in a component that affects the DC offset of the signal comprises detecting a change in a component that affects the DC offset of the signal.

6. The method of claim 5 wherein detecting a change in the component that affects the DC offset of the signal comprises detecting a gain change.

7. The method of claim 1 wherein adjusting the cutoff frequency of the high-pass filter from the first frequency value to a second frequency value comprises:
maintaining the cutoff frequency value at the first frequency value for a first time period; and
maintaining the cutoff frequency value at the second frequency value until detecting a change in the DC offset of the signal or a change in a component that affects the DC offset of the signal.

8. The method of claim 7 wherein adjusting the cutoff frequency of the high-pass filter from the first frequency value to the second frequency value further comprises:
adjusting the cutoff frequency from the first frequency value to a first intermediate frequency value;
maintaining the cutoff frequency value at the first intermediate frequency value for a second time period;
adjusting the cutoff frequency from the first intermediate frequency value to a second intermediate frequency value; and
maintaining the cutoff frequency value at the second intermediate frequency value for a third time period.

9. The method of claim 8 wherein the first, second, and third time periods are determined from values stored in a time period table.

10. The method of claim 8 wherein the first time period is less than the second time period and the second time period is less than the third time period.

11. The method of claim 1 wherein adjusting the cutoff frequency of the high-pass filter from the first frequency value to a second frequency value comprises:
adjusting the cutoff frequency value to one or more intermediate frequency values; and
adjusting the cutoff frequency from the one or more intermediate frequency values to the second frequency, the one or more intermediate frequency values being between the first frequency value and the second frequency value.

12. The method of claim 1 wherein adjusting the cutoff frequency of the high-pass filter from the first frequency value to the second frequency value comprises:
adjusting the cutoff frequency from the first frequency value to an intermediate frequency value;
while the cutoff frequency is equal to the intermediate frequency value, determining that the DC offset of the signal is greater than a particular value; and
adjusting the cutoff frequency from the intermediate frequency value to the second frequency value in response to determining that the DC offset of the signal is greater than the particular value.

13. The method of claim 1 wherein the first and second frequency values are determined from values stored in a cutoff frequencies table.

14. A system comprising:
a mixer configured to mix an input signal with a local oscillator signal;
an amplifier coupled to the mixer and configured to amplify a mixed signal;
a high-pass filter configured to filter an amplified and mixed signal; and
a control circuit configured to:
detect a change in the direct current (DC) offset of the signal or a change in a component that affects the DC offset of the signal,
in response to the detected change, set a cut-off frequency of the high-pass filter to a first frequency value, and
while the signal is filtered using the high-pass filter, adjust the cutoff frequency of the high-pass filter from the first frequency value to a second frequency value, wherein the second frequency value is less than the first frequency value.

15. The system of claim 14 wherein setting the cut-off frequency of the high-pass filter to the first frequency value comprises adjusting the cutoff frequency from an initial frequency value to the first frequency value, the first frequency value being higher than the initial frequency value.

16. The system of claim 15 wherein the initial frequency value and the second frequency value are the same.

17. The system of claim 14 wherein detecting a change in the DC offset of the signal or a change in a component that affects the DC offset of the signal comprises detecting a change in the DC offset of the signal.

18. The system of claim 14 wherein detecting a change in the DC offset of the signal or a change in a component that affects the DC offset of the signal comprises detecting a change in a component that affects the DC offset of the signal.

19. The system of claim 18 wherein detecting a change in the component that affects the DC offset of the signal comprises detecting a gain change.

20. The system of claim 14 wherein the control circuit is configured to:
adjust the cutoff frequency value to one or more intermediate frequency values; and
adjust the cutoff frequency from the one or more intermediate frequency values to the second frequency, the one or more intermediate frequency values being between the first frequency value and the second frequency value.

21. The system of claim 14 wherein the control circuit is configured to:
maintain the cutoff frequency value at the first frequency value for a first time period; and
maintain the cutoff frequency value at the second frequency value until detecting a change in the DC offset of the signal or a change in a component that affects the DC offset of the signal.

22. The system of claim 21 wherein the control circuit is configured to:
adjust the cutoff frequency from the first frequency value to a first intermediate frequency value;
maintain the cutoff frequency value at the first intermediate frequency value for a second time period;
adjust the cutoff frequency from the first intermediate frequency value to a second intermediate frequency value; and
maintain the cutoff frequency value at the second intermediate frequency value for a third time period.

23. The system of claim 22 wherein the control circuit is configured to determine the first, the second, and the third time periods from values stored in a time period table.

24. The system of claim 22 wherein the first time period is less than the second time period and the second time period is less than the third time period.

25. The system of claim 14 wherein the control circuit is configured to:
adjust the cutoff frequency from the first frequency value to an intermediate frequency value;
while the cutoff frequency is equal to the intermediate frequency value, determine that the DC offset of the signal is greater than a particular value; and
adjust the cutoff frequency from the intermediate frequency value to the second frequency value in response to determining that the DC offset of the signal is greater than the particular value.

26. The system of claim 14 wherein the control circuit is configured to determine the first and second frequency values from values stored in a cutoff frequencies table.

27. A receiver comprising:
an antenna configured to receive a signal;
a radio frequency filter configured to filter the signal;
a low noise amplifier configured to amplify the filtered signal;
a mixer configured to mix the output of the low noise amplifier;
an analog-to-digital converter configured to convert the signal after it has been mixed; and
a digital signal processor configured to receive the converted signal and configured to:
filter the converted signal as a digital high-pass filter,
detect a change in the direct current (DC) offset of the signal or a change in a component that affects the DC offset of the signal,
in response to the detected change, set a cut-off frequency of the digital high-pass filter to the first frequency value, and
while the signal is filtered using the digital high pass filter, adjust the cutoff frequency of the digital high-pass filter from the first frequency value to the second frequency value, wherein the second frequency value is less than the first frequency value.

28. The receiver of claim 27 wherein setting the cut-off frequency of the digital high-pass filter to the first frequency value comprises adjusting the cutoff frequency from an initial frequency value to the first frequency value, the first frequency value being higher than the initial frequency value.

29. The receiver of claim 27 wherein the control circuit is configured to:
adjust the cutoff frequency value to one or more intermediate frequency values; and
adjust the cutoff frequency from the one or more intermediate frequency values to the second frequency, the one or more intermediate frequency values being between the first frequency value and the second frequency value.

30. The receiver of claim 27 wherein the control circuit is configured to:
adjust the cutoff frequency from the first frequency value to an intermediate frequency value;
while the cutoff frequency is equal to the intermediate frequency value, determine that the DC offset of the signal is greater than a particular value; and
adjust the cutoff frequency from the intermediate frequency value to the second frequency value in response to determining that the DC offset of the signal is greater than the particular value.

31. The receiver of claim 30 wherein the control circuit is configured to determine the first and second frequency values from values stored in a cutoff frequencies table.
